(19) United States
(12) Patent Application Publication
(10) Pub. No.: US 2016/0229211 A1
(43) Pub. Date: Aug. 11, 2016

(54) SHEETED MEDICAL ARTICLES WITH ADHERED WRISTBAND

(71) Applicants: William Becker, Lockport, NY (US); Vikaas Gupta, St. John, IN (US)

(72) Inventors: William Becker, Lockport, NY (US); Vikaas Gupta, St. John, IN (US)

(21) Appl. No.: 14/035,429

(22) Filed: Sep. 24, 2013

Related U.S. Application Data
(60) Provisional application No. 61/704,900, filed on Sep. 24, 2012.
(60) Provisional application No. 61/787,092, filed on Mar. 15, 2013.

(51) Int. Cl. B41M 5/52; C08L 19/02; A44C 5/00; C08L 1/02

(52) U.S. Cl. CPC B41M 5/52; C08L 1/02; C08L 19/02; A44C 5/0015

(57) ABSTRACT

Various sheeted medical articles are described. The articles can include a fibrous material that includes cellulose fibers, nylon fibers, and a synthetic latex material dispersed therein. The fibrous material is soft and exhibits desirable feel and skin-contacting qualities. The articles include one or more banding products such as wristbands or ankle bands. The banding products are securely retained within the sheet articles prior to use by one or more regions of adhesive. The articles can also include a collection of removable adhesive backed labels.

### REFERENCE TO RELATED APPLICATIONS

The present application claims priority to U.S. Provisional Application No. 61/704,900 entitled “Material for Sheeted Medical Articles” filed on Sep. 24, 2012, and U.S. Provisional Application No. 61/787,092 entitled “Sheeted Medical Articles with Adhered Wristband” filed on Mar. 15, 2013, each of which is incorporated by reference herein in its entirety.

### FIELD

The present subject matter relates to sheeted and web based products such as used in certain medical articles and applications and to materials suitable for such products. The sheeted articles are particularly well suited for use in association with patient identification products, including wristbands and ankle bands, and those which are conveniently provided in a printable sheet form.

### BACKGROUND

To help prevent medical errors due to patient misidentification, many hospitals and other heath care providers use patient identification bands, which are secured around a patient's wrist or ankle. Printed on or attached to such identification bands is information such as a patient's name, date of birth, identification number, and sometimes even the patient's picture and an assigned barcode. In addition, identification bands or other medical articles can receive other indicia or markings. Such information or markings can be applied upon the band or article by use of a conventional printer such as a laser printer, an inkjet printer, or a thermal printer for example. Prior to printing upon the band or article, it is preferred that the article be residing in a sheet form so that the sheet(s) containing the band or article can be fed directly into the printer. This practice requires that the band, article, and/or sheet containing such, be relatively thin and yet be sufficiently stable and rigid to undergo feeding and passage into the printer. Thus, the sheet and its component layers and materials must withstand the mechanical and thermal stresses of printing or other like operation.

Sheeted medical articles are known in the art, including those which carry or incorporate one or more band products such as wristbands or ankle bands. For patients with delicate or sensitive skin, it would be desirable to provide a skin contacting material in an identification band that is soft and does not irritate the skin. Although such materials are somewhat known in the art, they are typically expensive and/or are difficult to incorporate in a sheet or web form. Also, problems may arise with certain sheeted articles if the relatively long band products are not firmly retained in the sheet during printing or other operations prior to removal and affixment to a patient. For example, the band products may lift up or become detached along one or more edges from their associated sheet and thereby become lodged in a printer. In addition, the bands may undergo wrinkling or other unwanted changes.

Accordingly, a need exists for a sheeted article providing one or more band products which are securely retained in the sheet, yet which can be readily removed when desired. Moreover, it would be particularly desirable to provide such a sheeted article that can withstand the mechanical and thermal stresses of printing, exhibits desirable skin-contacting qualities such as softness, and is relatively inexpensive.

### SUMMARY

The difficulties and drawbacks associated with previously known products and practices are addressed in the present products and methods for sheeted or web based medical articles.

In one aspect, the present subject matter provides a sheet assembly comprising at least one sheet that includes fibrous material comprising cellulose fibers and nylon fibers intermingled with the cellulose fibers to thereby form a fibrous matrix. The fibrous material also comprises synthetic latex dispersed throughout the fibrous matrix.

In another aspect, the present subject matter provides a sheet assembly comprising a face sheet, and a backing sheet at least partially formed from a fibrous material. The fibrous material comprises cellulose fibers, and nylon fibers intermingled with the cellulose fibers to thereby form a fibrous matrix. The fibrous material also comprises synthetic latex dispersed throughout the fibrous matrix.

In another aspect, the present subject matter provides a method of forming an article having a skin-contacting face with improved softness. The method comprises incorporating a fibrous material in the article such that the fibrous material constitutes a skin-contacting face of the article. The fibrous material includes (i) cellulose fibers, (ii) nylon fibers intermingled with the cellulose fibers to thereby form a fibrous matrix, and (iii) synthetic latex dispersed throughout the fibrous matrix.

In one aspect, the present subject matter provides a medical article in sheet form comprising a face layer defining a top surface and an oppositely directed back surface. The face layer includes a first region including a paper material and a second region including a fibrous material including at least two populations of fibers bonded to one another. The first region and the second region are generally coplanar with one another. The face layer also defines at least one band in the second region of the face layer. The band has a first end, a second end, and a strap extending between the ends. The article also comprises a liner layer defining a top surface and an oppositely directed back surface. The article additionally comprises a first adhesive layer disposed between the face layer and the liner layer, the first adhesive layer extending proximate the first end of the band. The article also comprises a second adhesive layer disposed between the face layer and the liner layer. The second adhesive is different than the first adhesive. The second adhesive layer extends along the strap of the band. The article also comprises at least one release layer disposed alongside the first adhesive layer and the second adhesive layer.

In another aspect, the present subject matter provides a sheeted article providing at least one identification band. The sheeted article comprises a face layer including a fibrous material. The face layer defines at least one identification band. The band has a first end, a second end, and a strap extending between the first end and the second end. The article also comprises a liner layer, a region of a pressure sensitive adhesive extending along at least a majority of the first end of the band defined in the face layer, a region of a permanent adhesive extending along at least a majority of the strap of the band defined in the face layer, and at least one region of a release material in contact with at least one of the region of pressure sensitive adhesive and the region of permanent adhesive.

In still another aspect, the present subject matter provides an identification band. The band has a first end, a second end, and a strap portion extending between the first end and the second end. The band comprises a face layer that defines a top surface and a back surface. The band also comprises a liner layer that defines a top surface and a back surface. The liner layer is positioned along the face layer such that the top surface of the liner layer is directed toward the back surface of the face layer. The band also comprises a region of a first adhesive extending along the strap portion of the band between the face layer and the liner layer. The band also comprises a region of release agent extending along the first end of the band between the face layer and the liner layer. The band also comprises a region of a second adhesive extending along the first end of the band between the face layer and the liner layer and in contact with the region of the release agent. The band additionally comprises a region of a deadener extending along the region of the first adhesive and in contact with the first adhesive. Upon separation of the liner layer from the face layer, the first adhesive and the deadener remain associated with the liner layer.

In still another aspect, the present subject matter provides a method for releasably retaining a removable band in a sheet article including a face layer and a liner layer. The band is separable from the face layer by one or more diecuts defining the band perimeter. The method comprises providing an adhesive along the liner layer extending along at least a portion of the band length. The method also comprises providing a release agent and a deadener between the adhesive and an underside of the face layer. Upon removal of the band from the sheet article and separation from the face layer, the deadener is separated from the release agent and remains adhered to the adhesive on the liner layer, and the release agent accompanies the band.

In yet another aspect, the present subject matter provides a method of forming a sheet article including a removable band. The method comprises providing a face layer defining an underside. The method also comprises die cutting a band in the face layer. The band has a first end, a second end, and a strap extending between the first end and the second end. The method also comprises applying a pressure sensitive adhesive to the underside of the face layer along the first end of the band. The method also comprises applying a release agent to the underside of the face layer along the strap and the second end of the band. The method additionally comprises applying a deadener on the release agent. The method also comprises providing a liner layer defining a top face. The method also comprises applying a permanent adhesive on the top face of the liner layer at a location that will register with the applied release agent. The method also comprises applying a release agent on the top face of the liner layer that will register with the applied pressure sensitive adhesive on the underside of the face layer at the first end of the band. And, the method comprises mating the face layer and the liner layer together to thereby form the sheet article.

As will be realized, the subject matter described herein is capable of other and different embodiments and its several details are capable of modifications in various respects, all without departing from the claimed subject matter. Accordingly, the description is to be regarded as illustrative and not restrictive.

### BRIEF DESCRIPTION OF THE DRAWINGS

FIG. 1 is a schematic planar view of a sheeted article carrying a removable band in accordance with the present subject matter.

FIG. 2 is a schematic exploded view of the article depicted in FIG. 1 illustrating its components in greater detail.

FIG. 3 is a schematic partial perspective view of a region including the removable band of the article of FIG. 1.

FIG. 4 is a schematic cross sectional view of the band of FIG. 3 taken across line 4-4 in FIG. 3.

FIG. 5 is a schematic cross sectional view of the band of FIG. 3 taken across line 5-5 in FIG. 3.

FIG. 6 is a schematic cross sectional view of the band of FIG. 3 taken across line 6-6 in FIG. 3.

FIG. 7 is a process schematic flow chart illustrating a method of forming a sheeted article in accordance with the present subject matter.

### DETAILED DESCRIPTION

The present subject matter is directed to a sheeted medical article. In many embodiments of the present subject matter, the sheeted article comprises a fibrous material that can be incorporated into one or more layers of a sheeted article. The fibrous material can be in sheets or webs used to form a variety of medical articles. The fibrous material can be incorporated into a layer such as a face layer, a backing layer, a substrate layer, and/or a skin contacting layer. In various embodiments, the medical articles include band products such as wristbands and ankle bands, which can be used as, but not limited to, patient identification products and relatively thin laminates used in medical applications. The bands include one or more regions of adhesive along their rear face which ensures that the bands remain securely retained within the sheet until removal.

### Fibrous Material

In one embodiment of the present subject matter, a fibrous material is provided that can be incorporated into one or more layers of a sheeted article. The fibrous material generally includes at least one type or population of fibers formed from cellulose, nylon, polypropylene, polyolefin, and similar materials; and at least one emulsion agent such as a natural or synthetic latex material, or an emulsion agent of another polymer with a low glass transition temperature. An example of the fibrous material is a fibrous material that comprises cellulose fibers, synthetic latex and nylon fibers. More specifically, the material comprises cellulose or paper-based fibers and nylon fibers intermingled with one another, and dispersed in a synthetic latex. The components can be combined or assembled in different configurations or combinations. A useful combination is to combine the cellulose fibers with the synthetic latex. This may result in a coating of the latex on all or a portion of the cellulose fibers. In certain versions, the cellulose fibers are coated, impregnated or saturated with the latex. However, the material also includes combining the nylon fibers with the synthetic latex which may result in the nylon fibers being coated, impregnated or saturated with the latex. Moreover, the material also includes combining the cellulose fibers and the nylon fibers concurrently or substantially so, with the synthetic latex.

Generally, the populations of fibers, e.g. the cellulose fibers and the nylon fibers, as described herein, are bonded to one another at all or a portion of their intersecting locations. The term “intersecting locations” as referred to herein refers to locations at which neighboring or adjacent fibers cross one another, contact one another, or substantially cross or contact one another. The bonding can be the result of heat bonding, or result from the latex material at the intersecting location(s) of interest. In certain versions of the present subject matter, at least a portion of the synthetic latex is disposed at intersecting locations of the cellulose and nylon fibers and serves to bond those fibers together. Other techniques for bonding can be used such as solvent bonding, mechanical bonding, ultrasonic bonding, needle punching, hydroentanglement, and stitchbonding. Conventional fiber processing operations can also be used to combine and/or to intermingle the various fibers with one another.

Nearly any type of cellulose fiber can be utilized. Similarly, nearly any type of synthetic latex material can be used. And, depending upon the intended application, a wide array of nylons can be used. The latex material is a synthetic latex material thus designating that the material is preferably not derived from natural rubber sources. A useful guide for the proportion or amount of nylon fibers is based upon the tear strength requirements of the final product. Typically, increasing the proportion of nylon fibers in the material will increase the tear strength of the material. Generally, a majority proportion of cellulose fibers and latex are used, in combination with a minority proportion of nylon fibers. In certain embodiments, the proportion of nylon fibers in the material is about 10% by weight. However, it will be appreciated that the present subject matter includes the use of proportions of these components different than described herein.

The fibrous material can also include a wide array of other fibers, components and agents such as, but not limited to, fibers formed from a wide array of polymeric materials, particulates, antimicrobial agents, UV blockers or similar agents, colorants, pigments, stabilizing agents, or other ancillary components. The material or rather the fibers of the material could receive one or more coatings or have additional materials dispersed within the fibrous matrix. The coatings or additional materials could include for example antimicrobial agents, release agents such as silicone release agents, laser imprintable coatings, or primer coatings. Combinations of any of these are also contemplated.

The thickness of the fibrous material generally depends upon the requirements of the intended application. Typical thicknesses of the material are within a range of from about 3 mils to about 7 mils, and particularly about 6 mils.

A preferred material comprising the previously described cellulose fibers, nylon fibers, and synthetic latex dispersed within the fibrous matrix exhibits the following properties as shown in Table 1.

TABLE 1
Preferred Properties of Fibrous Material

| | | English Units | | Metric Units | |
|---|---|---|---|---|---|
| Caliper (Thickness) | | 5.6 | Mils | 142μ | |
| Tensile | MD | 27.0 | lbs/inch of width | 47.3 | N/cm of width |
| Strength | CD | 22.0 | lbs/inch of width | 38.5 | N/cm of width |
| Elongation | MD | 6.0% | | 6.0% | |
| | CD | 12.0% | | 12.0% | |
| Elmendorf Tear | MD | 170 | grams | 170 | grams |
| Resistance | CD | 180 | grams | 180 | grams |

| Opacity | 70% | | 70% | |
|---|---|---|---|---|
| Brightness | 90% | | 90% | |
| Basis Weight | 60.0 | lbs/3000 ft² | 97.6 | gsm |

Elemendorf Tear Resistance is determined in accordance with TAPPI T414. Tear Strength is determined in accordance with ASTM D624. Elongation is determined in accordance with TAPPI T404. Opacity is determined according to TAPPI T425. And, brightness is determined by TAPPI T525.

Generally, the fibrous material comprising cellulose fibers, nylon fibers, and synthetic latex can exhibit a range of properties and is not limited to the particular properties set forth in the table above. For example, the fibrous material may exhibit a tensile strength in the machine direction (MD) of from about 20 to about 35 lbs/inch of width, and in the cross direction (CD) of from about 15 to about 30 lbs/inch of width. The fibrous material may exhibit an elongation in the machine direction of from about 2% to about 15%, and in the cross direction of from about 6% to about 25%. The fibrous material may exhibit an Elmendorf Tear value in the machine direction of from about 100 to about 300 grams, and in the cross direction of from about 100 to about 320 grams. The fibrous material may exhibit an opacity of from about 50% to about 90%. The fibrous material may exhibit a brightness of from about 70% to about 95%. And, the fibrous material may exhibit a basis weight of from about 30 to about 120 lbs/3000 ft². It will be understood that the present subject matter includes similar fibrous materials exhibiting different properties and/or combinations of properties than these.

The fibrous material(s) described herein exhibit remarkably soft characteristics. Layers of the fibrous material are soft to the skin and are non-irritating.

### Sheeted Article

The sheeted article can comprise any suitable number of layers as desired. Generally, the sheeted articles comprise a top or face layer and a bottom or liner layer and so, utilize a bilayer configuration. The liner/bottom layer can also be referred to herein as a backing layer. In many embodiments, each layer or component includes particular features or combinations of features as described herein. The sheet articles of the present subject matter are not limited to a bilayer configuration. Instead, the present subject matter also comprises sheeted articles that include additional components and/or layers, many of which are described herein. Such layers can include, but are not limited to, a substrate, a skin contacting layer, etc. As previously described, the fibrous material can be used in or as various layers of the sheeted article. In one embodiment, a face layer includes the fibrous material. In another embodiment, a backing layer includes the fibrous material.

The sheeted articles can include additional components or items in association with identification bands. In many of the embodiments described herein, the articles also comprise one or more labels. The labels can receive indicia such as from printing and are readily removable from the sheet. After removal, the labels typically include a layer of a pressure sensitive adhesive along their exposed rear face. Another example of component(s) which may be formed or otherwise included in the sheeted articles is an optional card. Card(s) can be included and may receive indicia or other elements as desired.

### Face Layer

In many embodiments of the present subject matter, the face layer is substantially rectangular and can be formed at least partially from a woven material, such as polyester, that has been impregnated with a compatible filler, such as polyester or nylon. The filler is applied sufficiently to define a relatively smooth continuous surface that will accept and retain printed indicia. Also, the face sheet can be formed at least partially from a spun material and/or a non-woven material, which can be, for example, polyethylene, polypropylene, polyethylene terephthalate, polyvinyl chloride, or mixtures thereof. Spun materials are non-woven materials that typically are made from polymeric fibers. The fibers are oriented in a seemingly random orientation to resemble cloth or fabric. The fibers can be bonded together via chemical, mechanical, heat, and/or solvent treatment(s). Woven materials typically are made from fibers that are oriented generally parallel to one another and can be bonded together via chemical, mechanical, heat, and/or solvent treatment(s).

In certain embodiments, the face layer is formed from multiple materials segregated by area or surface region. For example, in certain embodiments, paper or a paper-based material is used in one region of the face layer and a polymeric material such as a woven, spun, or non-woven material can be used in another region of the face layer. A particular embodiment includes a paper material in a region of the face layer at which a plurality of removable labels are provided, and a fibrous material as described herein in a region of the face layer at which one or more bands are provided. In certain embodiments, the multiple regions of different materials, e.g. paper and fibrous materials, are arranged such that they are coplanar with one another. That is, the different materials or regions of different materials are arranged such that they extend generally within a single, common plane. However, it will be appreciated that the present subject matter includes other arrangements and configurations.

The face layer in certain embodiments has a thickness of about 5 mils, and can range in thickness from about 1.0 mil to about 6.0 mils. As noted, the face layer typically receives printed indicia. The printed indicia can include, for example, high-resolution images and/or a barcode, e.g., a 2-D barcode or a 3-D barcode.

Generally, one or more identification bands or their perimeter are defined on the face layer by a corresponding plurality of arrays of die cuts. The die cut arrays can be die cut, laser cut or otherwise formed to extend through or substantially through the face layer at a plurality of spaced apart locations thereon. The specific dimensions of the die cut arrays can vary depending upon the characteristics of the material from which the face layer is formed. However, the die cut arrays should be formed to permit separation of the identification bands from the face layer without excessive manipulation or force and without tearing either the identification bands or adjacent areas of the face layer. In certain embodiments, each die cut is a continuous die cut around the complete perimeter of all bands, cards, and/or labels. The length of each die cut and the lengths of the ties between die cuts will vary in accordance with the characteristics of the material from which the face layer is formed.

Each identification band generally includes a first end, a second opposite end, and a strap portion extending between the ends. The strap has dimensions as described herein. The strap is sufficiently large to display the required information. In certain embodiments, the strap extends substantially symmetrically between the first and second ends. However, it will be understood that the present subject matter includes straps having a variety of shapes and sizes.

In certain embodiments, the face layer also includes or defines one or more labels. Typically, the labels are selectively removable and include a region of an adhesive along their rear face as described in greater detail herein.

In certain embodiments of the present subject matter, the face layer can optionally further include an identification card formed from one or more cuts. The identification card is typically rectangular, but may also include a tab extending from one long side thereof. The face layer can define other components and/or items.

The face layer includes a top surface or face and an oppositely directed underside or rear face. The top surface of the face layer can be imprinted with patient-specific indicia at locations corresponding to the identification band(s), the labels, the optional identification card, and/or other components.

As previously noted, in many embodiments, the face layer is a composite layer and includes materials in one or more areas which are different from materials used in other areas of the face layer. For example, in certain versions, the face layer includes a first region which is formed from fibrous materials described herein. And, the face layer can further include a second region which is formed from one or more paper materials. A typical arrangement in accordance with the present subject matter is providing one or more bands in the region formed from fibrous materials, and providing one or more labels in the region formed from paper materials. However, it will be appreciated that the present subject matter includes other arrangements and/or combinations of components and layer materials.

In versions of the sheet article utilizing paper in the face layer, a variety of paper materials can be used. For many applications, a laser imprintable paper is utilized. However, the subject matter includes other paper types having different characteristics and properties such as but not limited to papers adapted for use with ink jet printers. In addition, papers adapted for use with direct thermal or thermal transfer are also contemplated.

In certain embodiments of the present subject matter, a fibrous material as described herein can be incorporated in the face layer. And, in particular embodiments, the fibrous material is utilized in one or more regions of the face layer in which the identification band(s) are provided.

In certain applications, it may be desired to apply one or more top coats to the top or face surface of the face layer. For example, in certain versions, a thermal coating layer may be deposited, formed, or otherwise provided on the face layer.

The thermal coating layer is made of a material that facilitates thermal printing, e.g., direct thermal printing, of thermally-activated images or variable information, e.g., print and barcode information, within the face layer. Thus, the thermal coating layer's material (also referred to as a direct thermally activatable material) is heat activatable. In general, the thermal coating layer comprises a low solids water, a solvent, or a solventless borne liquid that includes a stoichiometric mixture of dye, sensitizer, and developer components. Representative materials from which the thermal coating layer can be made, include but are not limited to the following: NuCoat 8957 and 8952, which are provided by NuCoat of Plymouth, Minn. Representative waterborne versions of the thermal coating layer material include about 30-50% solids. Representative embodiments of the thermal coating layer material can include a leuco dye, a sensitizer, and a developer, which are intermixed and applied as a single coating to the substrate layer material.

Because the chemistry of the thermal coating layer's material typically is vulnerable to attack by alcohols, solvents, water, and/or other contaminants, a protective barrier coat, e.g., a topcoat layer, typically is applied over the thermal coating layer to protect the thermal coating layer. The topcoat layer includes a material that is resistant to abrasion and chemical or other environmental contaminants, e.g., organic contaminants, inorganic contaminants, and biological fluids. Accordingly, the topcoat layer is a protective layer that prevents damage to, or contamination of, the thermal coating layer. The topcoat layer can include organic water, solvent, or solventless liquid(s), for example, solvent-borne acrylics or silicones that can be dried or cured to develop its properties. Also, the topcoat layer can be UV curable. Examples of topcoat layer materials include the following: varnishes and other topcoat layer material provided by Acetega of Wesel, Germany, the Flint Group of Plymouth, Mich., and Ashland Inc. of Covington, Ky., for example, Acetega 814HSMW2 and Flint UVF02052. In certain embodiments, the topcoat layer is applied with a coatweight in the range between about 5 grams per square meter and about 20 grams per square meter.

In addition to providing resistance to contaminants, the topcoat coating layer also can be print-receptive to ink(s) and other medium. If the topcoat coating layer is not receptive to ink(s) or other medium, and such receptiveness is desired, an additional coating layer can be applied over the topcoat layer, such that the additional coating layer is coupled to the topcoat layer, to impart the desired properties. The additional coating layer has a thickness which can range in value from about 0.05 mils to about 0.25 mils. Thus, the overall thickness of representative embodiments of the face layer that include the additional coating layer with the substrate layer, the thermal coating layer, and the topcoat layer can range in value from about 3.3 mils to about 6.4 mils. The additional coating layer can be made from UV, or solvent-borne acrylics or silicones, and contain materials having abrasion-resistant properties, or other additives, depending on what finished performance properties are desired. An example of the material that can be used in the additional coating layer is varnish.

The sheeted articles of the present subject matter also comprise a liner or backing layer. In many embodiments, the liner layer is sized and shaped to correspond to the face layer and is adhered thereto as described herein. The liner layer is generally positioned along the face layer such that the top surface of the liner is directed toward the back surface or underside of the face layer.

In many embodiments, the liner layer is substantially rectangular and conforms to the size and shape of the face layer. The liner layer can be any flexible paper or film. In many embodiments of the present subject mater, the liner layer includes or is formed from one or more paper materials. Basically any paper with surface roughness suitable for feeding through a sheet fed printer can be used. Most roll fed printers use a super calendered (SCK) paper. In certain versions, the liner layer is a paper sheet with a thickness selected so that the sheet article can be processed efficiently through a conventional sheet-fed printer, such as a laser printer or ink jet printer. In various embodiments, the liner layer can include or be formed by a fibrous material as described herein. Currently available printers can process sheets with a thickness of 15 mils or less. A liner layer with a thickness of 2 mils to 6 mils would provide sufficient support for the sheet article while still permitting efficient processing through a conventional printing apparatus. The liner layer has a top surface, and an oppositely directed bottom or rear surface. As described in greater detail herein, a release coating is applied to one or more areas of the top surface of the liner layer that will register with the labels and one or more regions of the bands. Additional details of the release coating are provided herein.

In certain embodiments such as those which provide an identification card, the liner layer further includes an array of die cuts that will substantially register with the die cuts that define the optional identification card. Thus, the die cuts on the liner layer define an identification card support conforming to the size and shape of the identification card. For versions of the sheeted articles that do not include such card(s), the liner layer can be free of die cuts.

The back surface or underside of the face layer can be registered with, and secured to, the top surface of the liner layer to form the sheet article. The sheet article then can be processed through a printer, such as a laser printer, thermal, or inkjet printer to print patient specific indicia on at least the identification panel of each identification band, on one or more labels, and on the optional identification card. Patient specific indicia also can be printed on other portions of the top surface of the face layer.

The materials of the face layer and the liner layer of the printable sheets are selected based upon the end use requirements for the components of the sheet. In accordance with one embodiment of the present subject matter, the face layer includes or is formed from the previously described fibrous material. In accordance with other embodiments, the liner or backing layer can include the fibrous material described herein. Also and as previously noted, in forming the printable sheet assemblies described herein, a face layer composed of different materials can be used. For example, a face layer comprising one or more polymeric film materials can be used for certain regions of the sheet and different materials can be used on other regions. Similarly for example, a face layer comprising a woven material can be used in certain regions and a paper material can be used in other regions. In many embodiments of the present subject matter, the face layer is configured to be printed with indicia. The printing can be performed with a thermal printer, an inkjet printer, a laser printer, and/or by some other type of printer.

### Adhesives

The various embodiment sheets typically include a layer of one or more adhesives between the face layer and the liner layer. Generally, the adhesive is a continuous layer in the region of the labels defined in the face layer. In certain embodiments and as described in greater detail herein, the adhesive layer is discontinuous in certain regions. In these embodiments, the adhesive may be pattern coated. In certain embodiments, the adhesive is a pressure sensitive adhesive.

The present subject matter includes the use of at least two adhesives in the sheet article. A permanent adhesive is used along the strap portion of the band articles in the sheet, and a releasable pressure sensitive adhesive is used in other regions of the sheet and particularly along an end of the band articles. As previously noted, a pressure sensitive adhesive is also utilized in regions of the face layer that contain labels. The pressure sensitive adhesive used in association with the labels can be the same or different than the pressure sensitive adhesive used in association with the bands.

In certain versions, the permanent adhesive a hot melt rubber based permanent adhesive. Any permanent adhesive that is water resistant and bonds to the laser imprintable top coating would be a suitable candidate for use in the sheet articles. Potential suppliers of such adhesives include: HB Fuller, Henkel, Bostik, and Ashland.

The pressure sensitive adhesive has a composition that will remain stable and not flow or substantially not flow when subjected to temperatures as high as 300° F. to 400° F. These characteristics facilitate printing of the sheet assembly article in a laser printer or other high temperature printing apparatus. The adhesive also should not degrade easily when exposed to ultra-violet (UV) light. In this regard, exposure to ultra-violet light during normal use of the components of the sheet assembly should not turn the adhesive yellow or cause the adhesive to lose its tackiness. One such adhesive is described in U.S. Pat. No. 5,262,216 to Popat et al. A preferred adhesive is a hot melt adhesive which is available from Avery Dennison Corporation under the designation P32™. The pressure sensitive adhesive typically has a thickness in the range of about 0.25 mils to about 2.0 mils. Water based pressure sensitive adhesives are also suitable for many embodiments.

A wide variety of release coatings can be used in the sheet articles of the present subject matter. The various embodiment sheets typically include a release coating or layer of a release agent between the layer of adhesive and an adjacent layer such as the liner layer. Generally, the release agent or composition containing such is in the form of a continuous layer. In certain embodiments the release layer is discontinuous. In these embodiments, the release agent if initially in a liquid form, can be pattern coated. In certain versions, the release coating is a silicone material and more particularly, a UV cured silicone with an internally formulated release level deemed suitable for the application. Suitable suppliers include Momentive, Bluestar, Wacker, and Evonik. Other release compositions, such as fluorinated or amine based release compositions can be used. The release coating can be relatively thin, e.g., in the range of about 0.1 to 0.5 mils (2.5 microns to 13 microns).

The release agent is typically applied in a liquid form and then cured. UV curable release agents are suitable for many embodiments. UV curing release systems are generally either cationic or free radical systems. Thermally cured release agents can also be used.

### Deadener

In certain versions of the present subject matter, an adhesive deadener or more particularly, a coating of a deadener material can be incorporated in certain regions of the sheet articles. One or more deadener agents can be provided along a region or face of an adhesive layer to reduce or eliminate the tackiness of the adhesive. Deadener can be applied to a previously formed region or layer of release agent that is disposed along an adhesive layer. Instead of applying the deadener agent(s) to a previously deposited release face, it is also contemplated that the deadener(s) could be incorporated within the release agent material prior to its deposition. Alternatively or in addition, the deadener(s) could also be utilized in conjunction with adhesive materials as described in greater detail herein. A variety of adhesive deadeners are known in the art such as for example, the deadeners disclosed in U.S. Pat. Nos. 5,982,284; 7,575,791; and 7,579,059.

In certain versions of the present subject matter, the release material and the deadener material are used together or in conjunction with one another. The silicone or other release agent is applied first to desired regions of the underside of the face layer, and then any area that is to exhibit reduced or no tack is coated with deadener over the silicone. For example, deadener is applied on silicone on the underside of the face layer in the strap region of a band. A permanent adhesive is coated on a corresponding region of the liner layer and then the two layers are laminated together. Upon end user removal of the band, the deadener transfers from the silicone due to adhesion between the deadener and the permanent adhesive. In particular embodiments, both the deadener and the silicone are UV cured coatings.

It is also contemplated that instead of using a combination of release agent and deadener, a temporary adhesive which exhibited relatively low levels of tack or no tack, upon separation of the layers, could potentially be used. Such a temporary bonding adhesive could be used in place of release agent, deadener, and adhesive on the portion of the strap at which a pressure sensitive adhesive is not needed on the separated band.

### Identification Articles

As previously described, the various embodiment sheets may include one or more identification articles such as identification bands. The identification bands are typically attached to wrists and/or ankles of a patient in a hospital or healthcare environment. Indicia printed on the band can serve to identify the patient. Indicia printed on the band may also include information about the patient or the patient's care, therapy, or other conditions or characteristics. It will be appreciated that the present subject matter includes a wide range of uses and applications of the identification bands.

The identification band is formed from a thin flexible layer of one or more materials. The material can be a woven or nonwoven material. In certain versions, the material is the fibrous material described herein. Along a top side of the band, the band includes a material that will clearly display indicia imparted thereon by a commercially available printer, such as a laser printer, an inkjet printer, a thermal printer or the like. The material for receiving indicia can be a paper material or a non-paper material such as a polymeric or film material for example polyester, nylon polyvinyl chloride or other vinyl materials, and nonwoven or woven materials. Additionally, the fibrous material may be impregnated with a compatible synthetic material that will substantially fill voids between the fibers to define a sufficiently continuous and smooth surface for receiving and displaying printed indicia. The synthetic material impregnated into the fibrous material may be a polyester, styrene, acrylic or other compatible organic-based material. The identification band in certain embodiments is sufficiently thin and flexible to avoid irritating sensitive skin. Typical non-limiting thicknesses for the top side material of the identification band are from about 1.5 mils to about 4 mils (38 microns to 102 microns), and in certain embodiments from about 2 mils to about 3 mils (51 microns to 76 microns). Typical non-limiting thicknesses for the back side material for the identification band such as a woven material are from about 2 mils to about 5 mils (51 microns to 127 microns), and in certain embodiments about 3 mils (76 microns). Non-limiting thicknesses of an adhesive layer or regions thereof is between the top side and back side materials is from about 0.5 mils to about 1.5 mils (13 microns to 38 microns), and in certain embodiments about 1 mil (25 microns). It will be appreciated that in no way is the present subject matter limited to any of these values or dimensions.

Identification bands as described herein are particularly well suited for patients in a health care setting. Narrow width bands are especially well suited for the small wrists or ankles of infants. The band is sufficiently wide to provide the necessary strength and to prevent biting into the wrist or ankle of the patient. Additionally, the band in certain embodiments is wide enough to prevent twisting during normal use. A band of approximately 1.25 inches to about 0.25 inches (31.75 mm to 6.35 mm) wide is sufficient for these purposes. Again, the present subject matter includes a wide array of other dimensions and configurations. For example, in certain embodiments, the band has a width of from 0.25 to 2 inches (0.6 to 5.1 cm), more particularly from 0.4 to 1.5 inches (0.8 to 1.3 cm), and more particularly from 0.75 to 1.25 inches (1.9 to 3.2 cm). The band may have a length of from 4 to 12 inches 10.2 to 30.5 cm), more particularly from 5 to 11 inches (12.7 to 27.9 cm), and more particularly from 7 to 9.5 inches (17.8 to 24.1 cm).

Additional components, layers, and materials can be included in the identification bands. RFID HF or UHF components, generally referred to herein as RFID or RFID components, (such as available from Texas Instruments under the designation TAG IT or Avery Dennison's UHF products) may also be inserted during manufacturing to reside between the laminate layers, thereby securing the RFID safely, securely and permanently between or on the topside of the band. In addition, the compressible nature of a woven or non-woven fabric provides a protective cushion adjacent to the RFID to help it resist damage and can be made waterproof to further protect the identification band or RFID as well.

An important aspect of the various embodiments is the ability to print the identification band efficiently and reliably in a laser printer, thermal, an inkjet printer or other commercially available printing apparatus. Printers work best when the printed sheets are relatively thin and have uniform thickness or coplanarity across the length and width of the sheet. Sheets that are too thick may not feed well in many machines and sheets that do not exhibit coplanarity across the sheet are likely to jam or otherwise become lodged in the feed mechanisms of the printer.

The identification band of the embodiments in certain versions is part of a laminated sheet assembly that includes a face sheet and a liner or backing sheet. In certain embodiments, the face sheet is formed from the previously described fibrous material. The face sheet has a top surface on which the indicia is imprinted and a back surface that requires no indicia. In these or in other embodiments, the liner sheet may be formed from an array of materials such as paper materials with opposite top and back surfaces. In other embodiments the backing is formed from the previously described fibrous material. The top surface of the liner layer is secured at least temporarily in face-to-face engagement with the underside or rear surface of the face sheet.

In many embodiments of the identification band, at least one of the face layer and/or the liner layer is provided with at least one array of die cuts to define the shape for the identification band. The die cuts can be dimensioned to hold or further assist in retaining the identification band as part of the entire face sheet as the laminated sheet assembly is being processed through a printer. However, in certain versions of the present subject matter, die cuts that define the shape of the band are only formed in the face layer, and are not formed in the liner layer. This enables a “peel off” band as described in greater detail herein.

In a particular version of the present subject matter, a composite face layer is provided that comprises a first region formed from paper that includes a plurality of labels, and a second region formed from a fibrous material that includes one or more bands. A region of adhesive, and particularly a pressure sensitive adhesive is disposed along a rear face of the face layer in the region of the labels and on a first end of the band(s). And, sequential coatings of silicone and deadener are disposed along the rear face of the face layer in regions of the strap(s) of the band(s).

The top surface of the liner layer, i.e. the surface or face of the liner that contacts the underside of the face layer, includes a release coating in the region of the labels. And, the top surface of the liner layer also includes a region of release coating corresponding to the first end(s) of the band(s) which include region(s) of adhesive applied to the underside of the face layer. And, the top surface of the liner layer includes a region of an adhesive and particularly, a permanent adhesive along the regions corresponding to the strap(s) of the band(s). These and other aspects are described in greater detail herein.

In certain versions of the present subject matter, the identification bands exhibit particular characteristics. For example, the band can include an exposed region of a pressure sensitive adhesive at only one end of the band. In addition or alternatively, after its removal from the sheet, the band can include a rear face in the strap region that includes a deadened adhesive face.

### Methods

The present subject matter also provides various methods. In one embodiment, a method of forming an article having a skin-contacting face with improved softness is provided. The method generally comprises incorporating a fibrous material as described herein in the article such that the fibrous material constitutes a skin-contacting face of the article. The methods may optionally also comprise one or more printing operations in which indicia or other markings are printed on one or more layers of the article such as on a face sheet. The printing can be performed by a thermal printing technique, an inkjet printing technique, a laser printing technique, or by some other printing technique.

As previously explained, in certain embodiments, the liner layer under the labels receives a silicone release coating. The liner layer under the band(s) receives silicone release coating only at the end portion of the band(s). A region of a pressure sensitive adhesive can be applied over the silicone release coating at the end portion of the band(s). The liner area under the strap portion of the band(s) receives permanent adhesive. The rear face or underside of the face layer in the strap portion of the band(s) corresponding with the permanent adhesive (except for the adhesive end portion of the band) receives a silicone release coating. The silicone release coating receives a deadener in this region. The face layer and the liner layer are joined together. Upon removal of the band from the sheet article, the permanent adhesive corresponding to the deadener separates the deadener from the silicone thereby simulating a non-adhesive bond or no tack. The silicone release coating remains along the strap portion. As band removal progresses to the end of the band which includes a region of a pressure sensitive adhesive, the adhesive coated over the silicone transfers to the back side of the band within the end region because there is no silicone or deadener in that region.

Use or incorporation of the fibrous materials described herein can provide cost savings while providing a soft skin-contacting face for an article. The fibrous materials can readily be incorporated in a sheet or web assembly and are adapted for use or passage in a wide array of printers. Many other benefits will no doubt become apparent from future application and development of this technology.

### Embodiments

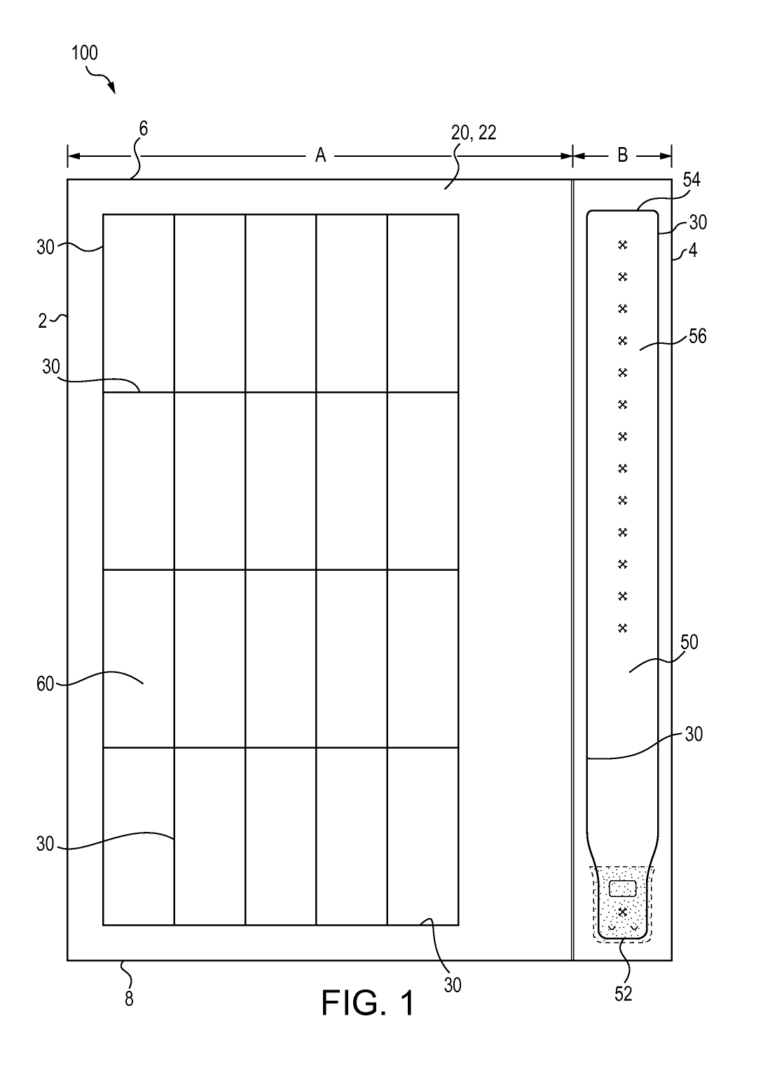

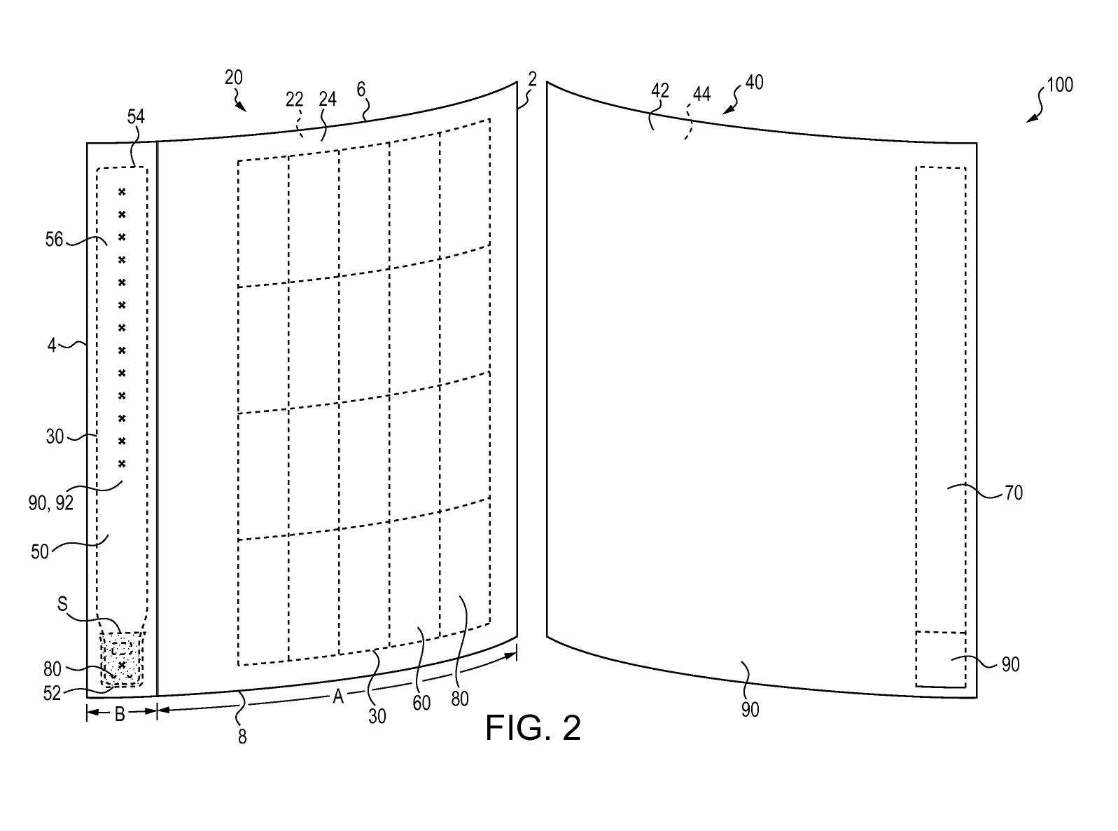

FIGS. 1-6 illustrate a representative embodiment of a sheeted article 100 in accordance with the present subject matter. The article 100 comprises a face layer 20 and a liner layer 40. The layers 20 and 40 are joined to one another and include regions of adhesives, release agents, and deadeners disposed between them. Referring to FIG. 2, the face layer 20 defines a top face 22 and an oppositely directed rear face 24. The liner layer 40 defines a top face 42 and an oppositely directed bottom or rear face 44. FIG. 1 illustrates these two layers aligned and joined with one another to form the article 100.

The article 100 defines a pair of lengthwise extending edges 2 and 4, and a pair of widthwise extending edges 6 and 8. In the particular embodiment shown, edges 2 and 4 are parallel with one another and edges 6 and 8 are also parallel with one another. Furthermore, the edges 6 and 8 are perpendicular to the edges 2 and 4. The face layer 20 includes two regions such as regions A and B shown in FIG. 1. The face layer 20 includes a paper material in region A and a fibrous material in region B. The face layer 20 also defines one or more die cuts 30 that in turn, define band(s) 50, labels 60, and other optional components (not shown).

The band 50 includes a first end 52, a second opposite end 54, and a strap 56 extending between the ends 52 and 54. Referring to FIG. 2 which illustrates the underside 24 of the face layer 20, a region of a pressure sensitive adhesive 80 is disposed along and proximate an end portion of the band 50 adjacent the first end 52 of the band. A first layer of a release agent 90 and a second layer of a deadener 92 are disposed along the strap 56 and the second end 54 of the band, along the underside 24 of the face layer 20. Another region of a pressure sensitive adhesive 80 is disposed along the underside face 24 of the face layer 20 in the region of the labels 60.

Continuing to refer to FIG. 2, the top face 42 of the liner layer 40 includes a region of release agent 90 that corresponds to the region(s) of pressure sensitive adhesive 80 associated with the labels 60 in the face layer 20. The liner layer 40 also includes a region of release agent 90 that corresponds to the region of pressure sensitive adhesive 80 associated with the first end 52 of the band 50 in the face layer 20. The liner layer 40 additionally includes a region of a permanent adhesive 70 that corresponds to the region of the release agent 90 and the deadener 92 along the strap 56 and second end 54 of the band 50. In certain versions, a gap or spacing S can be provided between the region of pressure sensitive adhesive 80 and the area of reduced or no tack resulting from the regions or layers of release agent 90 and deadener 92. A representative distance for this gap is from about 0.1 inch to about 0.5 inch (2.54 mm to 12.7 mm) and particularly about 0.125 inch (3.175 mm).

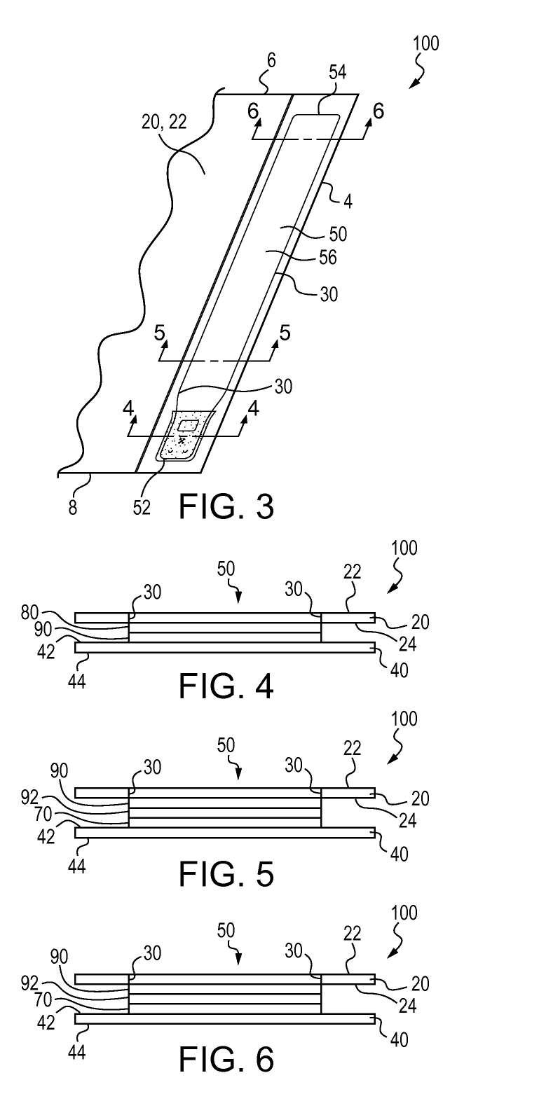

FIGS. 4-6 illustrate schematic cross sectional views of the band 50 at various locations and as shown in FIG. 3. It will be appreciated that FIGS. 4-6 are schematic in nature and thus, no significance is to be attributed to the relative thicknesses of the layers. FIG. 4 is a cross sectional view of the band 50 taken along line 4-4 in FIG. 3 proximate the first end 52 of the band 50. A region of release agent 90 is disposed on the liner layer 40 and particularly, upon the top face 42 of the liner layer 40. A correspondingly shaped and sized region of a pressure sensitive adhesive 80 is disposed between the region of release agent 90 and the underside 24 of the face layer 20. FIG. 5 is a cross sectional view of the band taken along line 5-5 in FIG. 3 along the strap 56 of the band 50. A region of permanent adhesive 70 is disposed on the liner layer 40 and particularly, upon the top face 42 of the liner layer 40. A correspondingly shaped and sized region of release agent 90 is disposed along the underside 24 of the face layer 20. And, a correspondingly shaped and sized region of deadener 92 is disposed between the region of release agent 90 and the region of permanent adhesive 70. FIG. 6 is a cross sectional view of the band 50 taken along line 6-6 in FIG. 3 proximate the second end 54 of the band 50. The materials and arrangement of layers depicted in FIG. 6 is the same as that shown in FIG. 5. This is because in the particular band embodiment 50, the regions at which lines 5-5 and 6-6 are taken, utilize the same configuration. However, it will be appreciated that the present subject matter includes bands having structures or utilizing different materials and/or layers at different regions.

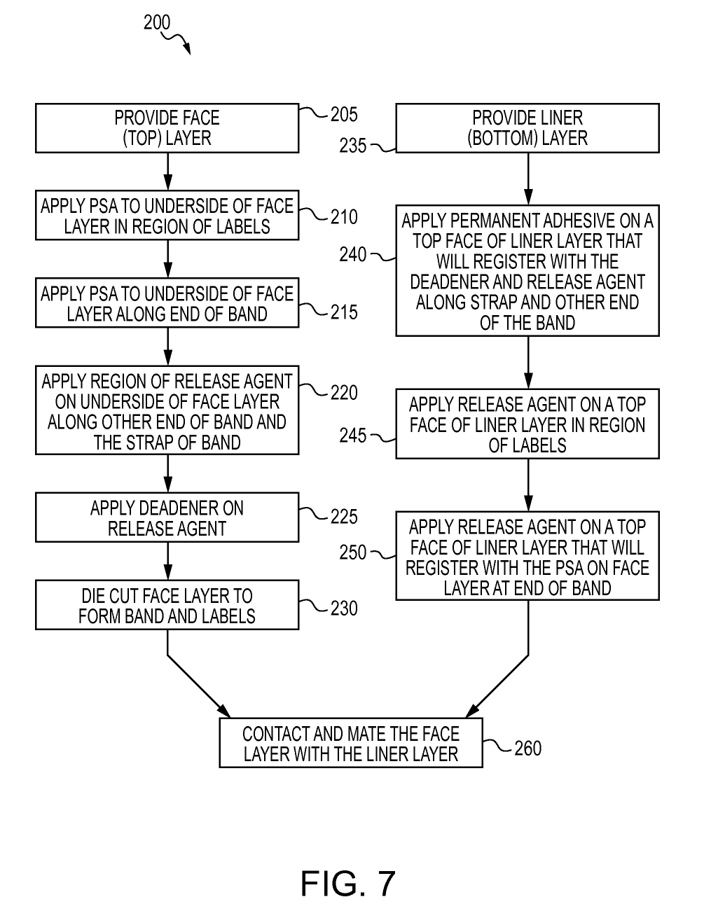

FIG. 7 is a flow chart illustrating a method 200 for forming a sheet article in accordance with the present subject matter. The method 200 comprises a series of operations involving a face layer such as the previously described face layer 20, and a series of operations involving a liner layer such as the previously described liner layer 40. The method 200 generally comprises providing a face layer, as denoted by operation 205. In operation 210, a coating or layer of a pressure sensitive adhesive is applied to the underside of the face layer in the region of any labels, such as labels 60 depicted in FIG. 2. In operation 215, a coating or layer of a pressure sensitive adhesive is applied to the underside of the face layer along an end of the band, such as region 80 depicted in FIG. 2. In operation 220 a coating or layer of a release agent such as a silicone release agent is applied on the underside of the face layer along the other end of the band and along the strap region of the band. This is shown as region 90 in FIG. 2. In operation 225, one or more deadener agent(s) is applied on the release agent previously applied in operation 220. Deadener 92 is shown along the underside of the face sheet and on the release agent 90, in FIG. 2. In operation 230, the face layer is appropriately die cut or subjected to other operation(s) to thereby define the band and labels.

The method 200 also comprises an operation of providing the liner layer, such as in operation 235. In operation 240, a permanent adhesive is applied on the top face of the liner layer that will register with the deadener and release agent along the strap and an end of the band. FIG. 2 illustrates a region 70 of permanent adhesive applied in such manner. In operation 245, a release agent is applied on the top face of the liner layer in the region of the labels. This is shown in FIG. 2 in which release agent 90 is disposed on the liner 40 in a region corresponding to the labels 60. In operation 250, a release agent is applied on the top face of the liner layer that will register with the pressure sensitive adhesive on the face layer at an end of the band. This is shown in FIG. 2 in which a region 90 of release agent is disposed on the liner 40 at a location that will register with the pressure sensitive adhesive 80 on the face layer 20 at the end 52 of the band. And, the method 200 comprises an operation 260 of contacting and mating the face layer and the liner layer with one another to thereby form a sheet article.

It will be understood that the present subject matter includes variations of the method 200. For example, die cutting operations shown as operation 230 in FIG. 7 could be performed prior to or after one or more other operations illustrated. Furthermore, if the sheet article does not include labels, then operations such as operation 210, are not necessary.

All patents, applications, standards, and articles noted herein are hereby incorporated by reference in their entirety.

As described hereinabove, the present subject matter overcomes many problems associated with previous strategies, systems and/or articles. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

1. A sheet assembly comprising at least one sheet that includes a fibrous material comprising:
cellulose fibers;
nylon fibers intermingled with the cellulose fibers to thereby form a fibrous matrix; and
synthetic latex dispersed throughout the fibrous matrix
wherein the sheet assembly includes an identification wristband having a skin contacting face configured to contact skin of an associated user.

2. The sheet assembly according to claim 1, wherein the fibrous material has a thickness between approximately 3 mils and approximately 7 mils.

3. The sheet assembly of claim 1, wherein the weight proportion of the nylon fibers in the fibrous material is a minority proportion.

4. The sheet assembly of claim 3 wherein the weight proportion of the nylon fibers is about 10%.

5. The sheet assembly of claim 1, wherein at least a portion of the synthetic latex is disposed at intersecting locations of the cellulose fibers and the nylon fibers and bonds the cellulose fibers with the nylon fibers.

6. The sheet assembly of claim 1, wherein the fibrous material exhibits a tensile strength in a machine direction of from about 20 lbs/inch of width to about 35 lbs/inch of width, and in a cross direction of from about 15 lbs/inch of width to about 30 lbs/inch of width.

7. The sheet assembly of claim 1, wherein the fibrous material exhibits an elongation in a machine direction of from about 2% to about 15%, and in a cross direction of from about 6% to about 25%.

8. The sheet assembly of claim 1, wherein the fibrous material exhibits an Elmendorf Tear value in a machine direction of from about 100 grams to about 300 grams, and in a cross direction of from about 100 grams to about 320 grams.

9. The sheet assembly of claim 1, wherein the fibrous material exhibits an opacity of from about 50% to about 90%.

10. The sheet assembly of claim 1, wherein the fibrous material exhibits a brightness of from about 70% to about 95%.

11. The sheet assembly of claim 1, wherein the fibrous material exhibits a basis weight of from about 30 lbs/3000 ft² to about 120 lbs/3000 ft².

12. The sheet assembly of claim 1, wherein the sheet assembly comprises a face sheet and a backing sheet, wherein at least the face sheet includes the fibrous material.

13. The sheet assembly of claim 1, wherein the sheet assembly comprises a face sheet and a backing sheet, wherein at least the backing sheet includes the fibrous material.

14. (canceled)

15. The sheet assembly according to claim 12, wherein the face sheet is configured to be thermally printed, inkjet printed, and/or laser printed with indicia.

16-73. (canceled)

74. The sheet assembly of claim 12, wherein the weight proportion of the nylon fibers in the fibrous material is a minority proportion.

75. The sheet assembly of claim 74, wherein the weight proportion of the nylon fibers is about 10%.

76. The sheet assembly of claim 12, wherein at least a portion of the synthetic latex is disposed at intersecting locations of the cellulose fibers and the nylon fibers and bonds the cellulose fibers with the nylon fibers.

77. The sheet assembly of claim 12, wherein the fibrous material exhibits a tensile strength in a machine direction of from about 20 lbs/inch of width to about 35 lbs/inch of width, and in a cross direction of from about 15 lbs/inch of width to about 30 lbs/inch of width.

78. The sheet assembly of claim 12, wherein the fibrous material exhibits an elongation in a machine direction of from about 2% to about 15%, and in a cross direction of from about 6% to about 25%.

79. The sheet assembly of claim 12, wherein the fibrous material exhibits an Elmendorf Tear value in a machine direction of from about 100 grams to about 300 grams, and in a cross direction of from about 100 grams to about 320 grams.

80. The sheet assembly of claim 12, wherein the fibrous material exhibits an opacity of from about 50% to about 90%.

81. The sheet assembly of claim 12, wherein the fibrous material exhibits a brightness of from about 70% to about 95%.

82. The sheet assembly of claim 12, wherein the fibrous material exhibits a basis weight of from about 30 lbs/3000 ft² to about 120 lbs/3000 ft².
